(19) United States
(12) Patent Application Publication
(10) Pub. No.: US 2014/0074957 A1
(43) Pub. Date: Mar. 13, 2014

(54) Method and Apparatus for Social Information Exchange in a Vehicle

(71) Applicant: Ford Global Technologies, LLC, Dearborn, MI (US)

(72) Inventors: Yimin Liu, Ann Arbor, MI (US); Perry Robinson MacNeille, Lathrup Village, MI (US); Oleg Yurievitch Gusikhin, West Bloomfield, MI (US)

(73) Assignee: Ford Global Technologies, LLC, Dearborn, MI (US)

(21) Appl. No.: 14/083,882

(22) Filed: Nov. 19, 2013

Related U.S. Application Data
(62) Division of application No. 13/366,508, filed on Feb. 6, 2012.

(51) Int. Cl. H04L 29/08

(52) U.S. Cl. CPC H04L 67/12
USPC 709/206

(57) ABSTRACT

A computer implemented method includes receiving a request for a review relating to a merchant, good or service, from a requesting user through a vehicle computing system (VCS). The method also includes searching a group of reviews created by one or more users affiliated with a requesting user, the grouping having been created by the requesting user. Further, the method includes retrieving at least one review for delivery to the requesting user. The method also includes delivering the at least one review to the requesting user via the VCS.

### CROSS-REFERENCE TO RELATED APPLICATIONS

This application is a division of U.S. application Ser. No. 13/366,508 filed Feb. 6, 2012, the disclosure of which is hereby incorporated in its entirety by reference herein.

### TECHNICAL FIELD

The illustrative embodiments generally relate to methods and apparatuses for social information exchange in a vehicle.

### BACKGROUND

In traditional marketing practice the four P's of marketing mix: promotion, price, product and placement information has been delivered to the public via printed matter, broadcast radio/TV, etc. Business transactions typically took place on a merchant's premises. For the past fifteen years, the World Wide Web has been used to deliver advertising, which has made advertising information instantly accessible. The Internet has also aided in delivering targeted advertising, due at least in part to informational filters available to advertisement deliverers.

Part of the information relating to goods that is available online comes in the form of referrals. While often useful in telling prospective buyers about previous buyers' experiences, there are some potential shortcomings to referrals. For example, there is the potential concern that a store owner or merchant could possibly be writing a “fake” review, designed to prop up their own product. In another instance, even if there isn't a nefarious purpose behind a review, varying tastes of unknown parties writing reviews may be completely different from preferences/expectations of the readers. This situation can lead to misleading information being gathered from reviews, even if the reviewer was simply trying to be helpful.

### SUMMARY

In a first illustrative embodiment, a computer implemented method includes receiving a request for a review relating to a merchant, good or service, from a requesting user through a vehicle computing system (VCS). The method also includes searching a group of reviews created by one or more users affiliated with a requesting user, via a grouping created by the requesting user. Further, the method includes retrieving at least one review for delivery to the requesting user. The method also includes delivering the at least one review to the requesting user via the VCS.

In a second illustrative embodiment, a computer implemented method includes providing a driver with an option to input a review relating to a place of business from which a vehicle just departed. The method also includes receiving a review relating to the place of business, responsive to the driver agreeing to input a review. Also, the method includes storing the review in a data repository such that the review is accessible at least by users who the driver has identified as being affiliates.

In a third illustrative embodiment, a computer implemented method includes receiving input, via a vehicle computing system (VCS), relating to a driver recommendation of a merchant, good or service. The method also includes identifying one or more users affiliated with the driver, based at least in part on driver identification of affiliates. Further, the method includes delivering the recommendation to the one or more users, including at least delivering the recommendation to one user who is currently driving a VCS equipped vehicle.

In a fourth illustrative embodiment, a computer implemented method includes providing a list of driver-affiliated users, based at least on a driver designation of affiliation, whose vehicle computing system (VCS)-equipped vehicles are currently powered. The method also includes receiving input corresponding to a selection of at least one user. Further, the method includes receiving a message for delivery to a vehicle computing system (VCS) of the selected at least one user(s). The method additionally includes delivering the message from a driver VCS to a VCS of the selected user(s).

### BRIEF DESCRIPTION OF THE DRAWINGS

FIG. 1 shows an illustrative example of a vehicle computing system;

FIG. 2 shows an illustrative example of a vehicle network social grouping system;

FIG. 3 shows an illustrative example of a social group;

FIG. 4 shows an illustrative example of group creation/joining;

FIG. 5 shows an illustrative example of a review gathering process;

FIG. 6 shows an illustrative example of a review provision process;

FIG. 7 shows an illustrative example of a review sorting process; and

FIG. 8 shows an illustrative example of a process for group communication.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

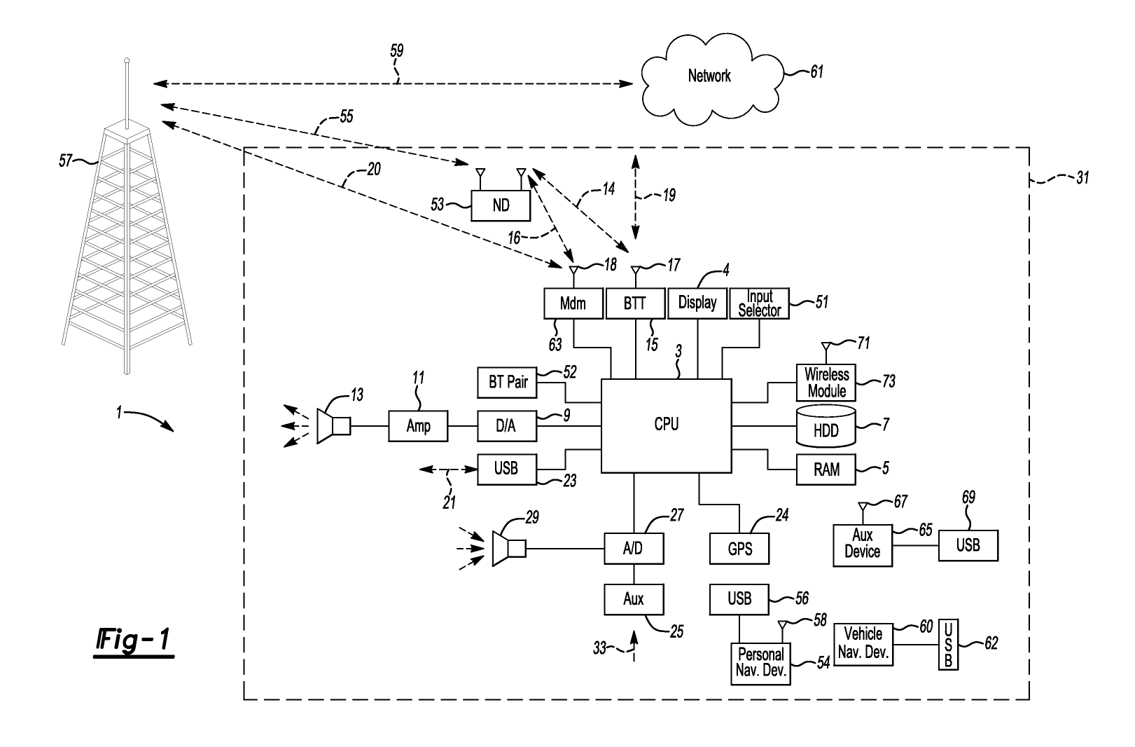

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In the illustrative embodiments, drivers can form a social group with other drivers using, for example, networked vehicle computing systems. The drivers can add friends to the social group, and exchange information with their friends. Reviews and evaluations provided by the drivers can even be published to social networks and other social media. Experiences using coupons, merchants, vendors, etc. can be shared with the group. Real time information exchange may also be possible, such as instant messaging between parties who are both in vehicles at the same time.

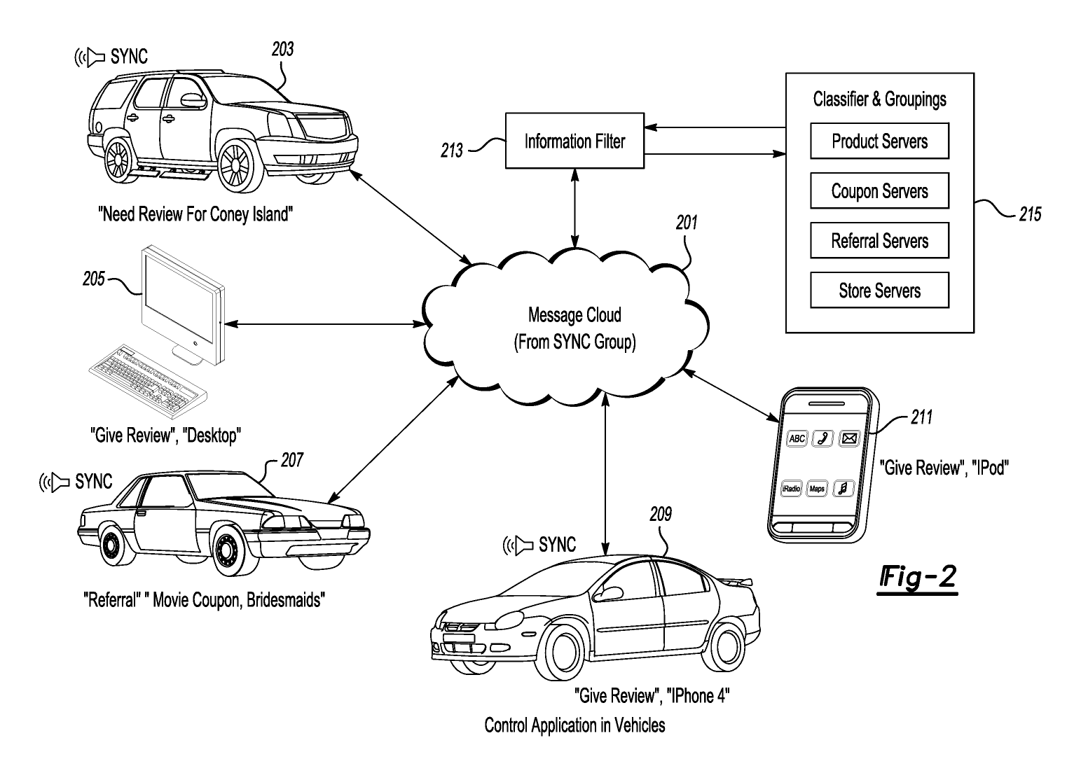

FIG. 2 shows an illustrative example of a vehicle network social grouping system. In this illustrative example, data is relayed between various vehicles in a social group over the cloud (e.g., the internet) 201. Individual users 203, 205, 207, 209, 211 may add or request various items of information through the group. Previously entered information can be stored on a remote storage device, such as a server or a database 215 (or a number of server/databases). Product information, coupon information, review information, merchant information, etc. can all be stored and served to users as requested. An informational filter can sift through the stored information and provide appropriate responses to various queries, as well as sort incoming reviews and store them categorically as desired.

For example, in the illustrative system shown in FIG. 2, a first user 203 may ask for a restaurant review. The review could be related to a query from a user, or it could be provided automatically if the user input an address corresponding to a restaurant, or requested directions to a specific restaurant. User 205 could be on a PC, providing a review for one or more products that had been purchased by the user.

User 207 could use a vehicle like the PC for providing a review, which may be useful if the user has just left a movie, merchant, restaurant, etc. for which a review is desired. In at least one instance, a coupon could have just been used by the user, and the user could be reviewing the coupon and/or experience. In some instances, the user may be capable of providing a copy of the coupon electronically to others receiving the review, or in the user's network.

Other users can use wireless devices 211, to provide reviews, and the devices can similarly be used to receive reviews. User identities associated with the devices can be used to process and deliver reviews. For example, if a person owning vehicle A adds a person owning vehicle B to their social group, the A user may also want to receive information delivered from a B user's phone, PC, handheld device, etc.

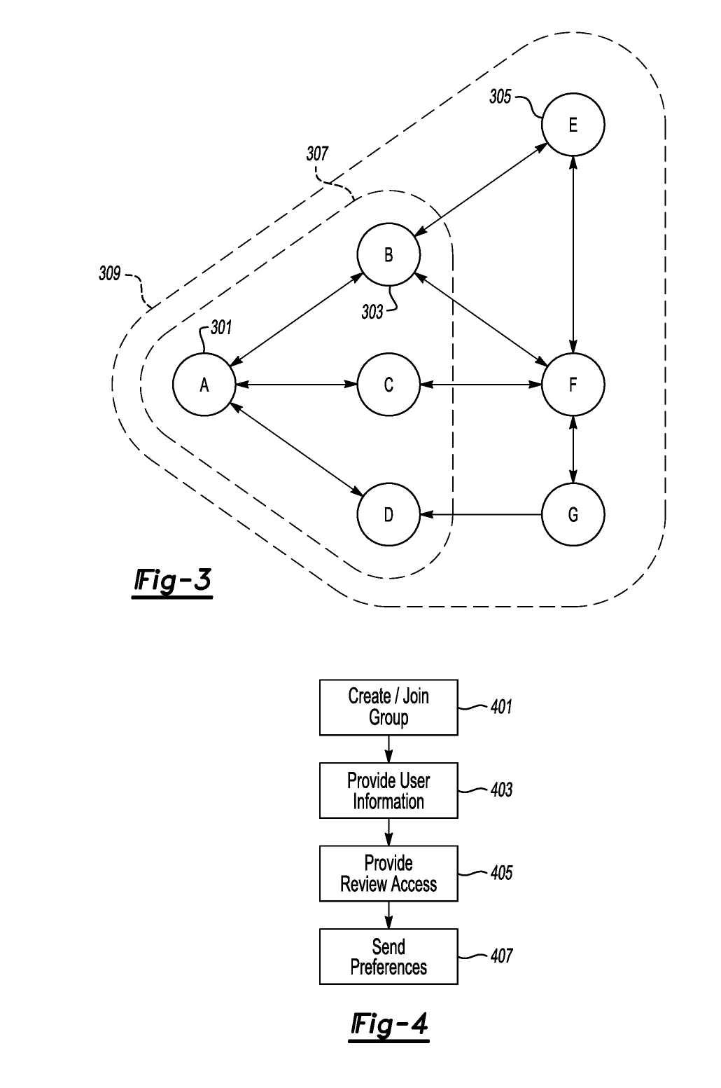

FIG. 3 shows an illustrative example of a social group. In this illustrative example, there are seven users, A-G. User A 301, is direct friends 303 with parties B, C and D. Party B is friends with A, C, E and F, Party C is friends with A, B, and F, etc. Each person in this group is removed no more than one degree 305 from any other person, although a far more complicated social network is possible.

In one instance, referrals and communication may be within a direct group of friends or other grouping definable by a user or a provider 307. This may be used for direct information exchange or for, for example, instant messaging. In another instance, it may be the case that direct referral/recommendation/review information is not available from a direct group of friends. An information filter, such as a collaborative filter, can expand the search group, in this case, to one level of friends removed 309. While not necessarily the case, people may be more likely to get good or usable information from friends of friends, as opposed to complete strangers.

FIG. 4 shows an illustrative example of group creation/joining In this illustrative process, the user can either create or join a friend group 401. In one case, each user will have their own group, but clusters of users can agree to form certain group as well. Groups having common interests can also be formed, for example, a movie watching group who likes the movies of a certain director could all share information/reviews/coupons/etc.

Once someone joins the group, the person provides personal information, or at least information necessary to communicate with other users and be part of the group 403. This information can, in some cases, also be used to add details on user's other devices, such as, but not limited to, PCs, handhelds, cell phones, tablet PCs, etc. Once the person has joined the group, they may have access to reviews, coupons, etc. posted to the group 405. They may also have the capability to add information to the group.

Also, as part of joining a group, the user can add one or more preferences 407. These preferences can relate to types of information shared, other user accounts, review preferences, etc. Permissions and preferences can also dictate which users can contact the particular user, and can include requests to certain users to join their groups or be added as their contacts.

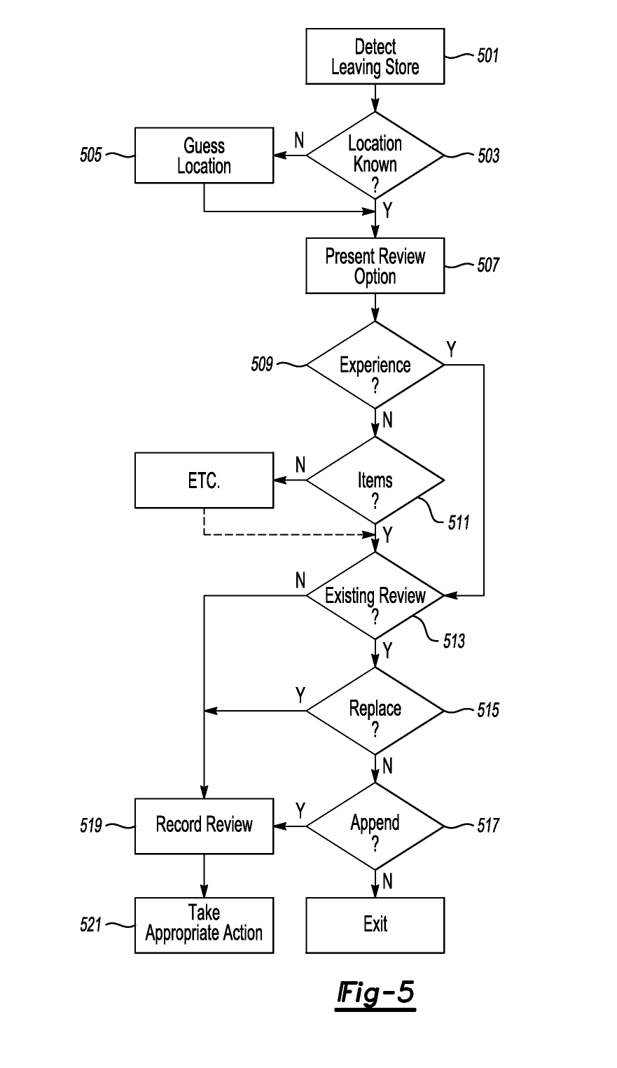

FIG. 5 shows an illustrative example of a review gathering process. This illustrative process detects that a vehicle is leaving a store or a location 501. This information may be useful, because it may be good to gather a review right after a user experienced whatever it is they are reviewing. This way, the information is fresh in the reviewer's mind.

If the location is known 503 (e.g., if the GPS location corresponds to a known store, business, merchant, vendor, etc.) the process may be able to auto-fill some details on the review information. For example, if a user is leaving a movie theater, the process could add that a movie was being reviewed, and even provide some form of review questionnaire related to movies. Based on the timing of the user's arrival and leaving, the process could even possibly determine a specific movie (or at least a list of only a few choices).

If the location is not known, the process may guess at a location 505, which can also be cross checked with the user to determine if the guess was correct. Once a location name/type has been established, the process can present one or more review options 507.

Different stores/businesses provide different services, and reviews may vary based on goods or services provided. For example, a person leaving a restaurant may wish to review food, service or both. A person leaving a hardware store, on the other hand, may want to review the store (inventory selection, for example), review customer assistance, or even review a product purchased at the store. One or more type of review options, such as, but not limited to experience 509, items 511, etc. may be presented for the user to select.

The user could also review more than simply one of the choices (e.g., review both products and services). Once the suitable selections of a review type have been made (which may aid in later classification of the review), the process checks to see if the user has previously input a review on the good/service/store 513. For example, if the customer has previously visited the location, or frequently visits a location, the customer may want to add to 517 or replace a previously entered review 515.

Once it is known what will be done with the review, the process can record a review 519. The review can be recorded in a vehicle, on a PC, from a handheld, etc. The review can include any coupons used, rating systems, verbal and typed testimony and any other suitable information. The user can also link the review to a specific store, as opposed to providing the review for all stores. On the other hand, if the review is a product, the process may link the review to all stores selling the product. Any appropriate action can be taken 521.

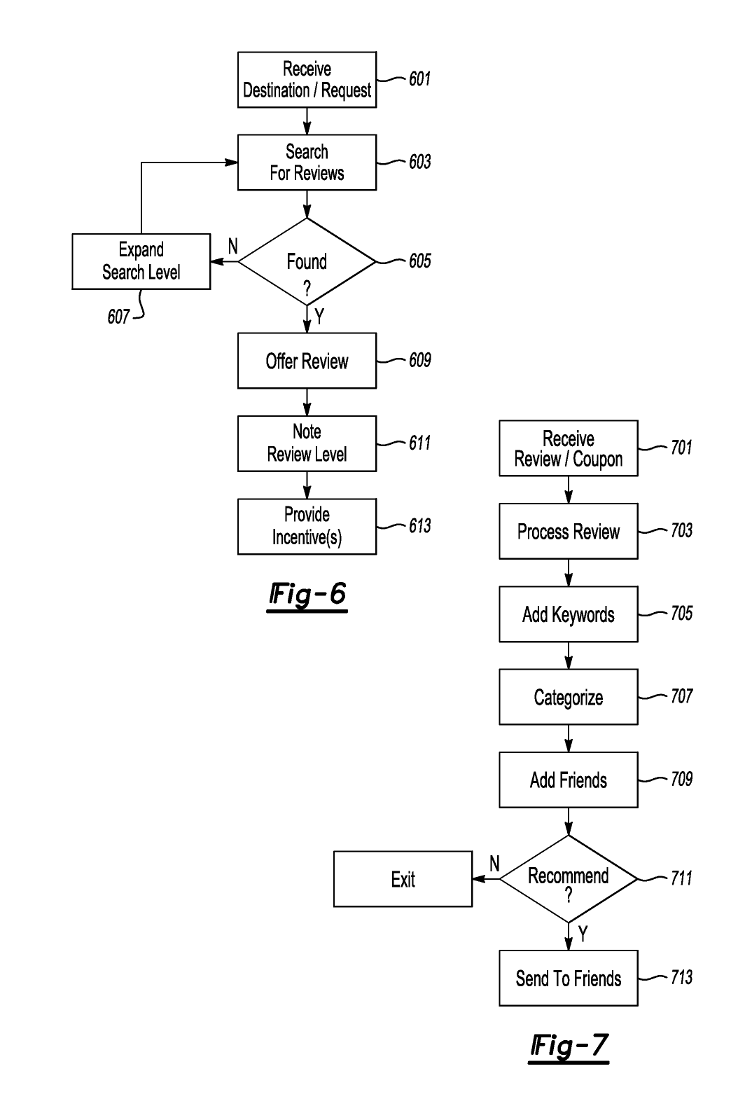

FIG. 6 shows an illustrative example of a review provision process. In this illustrative example, a review can be automatically provided, for example, when a destination or address corresponding to a known destination is entered. Additionally or alternatively, the process can receive a request from the user for a specific review on a good/merchant/service, etc. 601. Once an item for which a review is desired is known, the process can search for reviews 603.

In at least one instance, the process will search a specific group first for a review 603. The group could be a group of immediate friends, expanded friends, people with similar interests or even people with similar personalities. In this illustrative example, the process first searches a group of immediate friends to see if a review on the requested item can be found 605. If no review is found, the process can expand a search level 607. For example, with respect to FIG. 3, the first search level could be friends B, C and D, and a next search level could be E, F and G. Searches can be expanded all the way to include an entire user network, if more localized reviews are not found.

Once a review is found, the process can offer one or more reviews to the user 609 for reading. The process can offer to read the review to the user, display the review for reading, sort multiple reviews based on usefulness, good/bad review, etc. In addition to offering a review, the process can notify the user as to which level from which the review was derived 611. This may help a user decide whether or not to read a review, or how much stock to put into a particular review. For example, a review from a trusted friend may be worthwhile to someone, but a review drawn from an unknown source fifteen hundred miles away may be marginally useless.

Reviews may also include coupons or other incentives for a user to follow through on a review 613. In one instance, the review may actually be a review of an experience that accompanied a coupon. A copy of the coupon, or a different version of the coupon for the same item/store/business can be included with a review. Coupons can be transferred electronically to a user, for example, by email or SMS message.

FIG. 7 shows an illustrative example of a review sorting process. In this illustrative example, the process receives a review/coupon for which information is being provided 701. As previously noted, this can relate to a service, good, movie, coupon, etc. Accompanying the review can also be user information, usable to sort through various reviews. The GPS data of a vehicle can be included with the review, as can any other data that may be useful in review categorization, processing and later provision. The process can use all of the attached data, or any of the attached data, to sort the review 703.

The process can also add a number of keywords to a particular review 705, such as words that later can be used when the process is searching for reviews to distribute. Other information can be added as well, and keywords can include words relating to user names, quality of reviews, usefulness of reviews as decided by previous users, etc. Once keywords have been added, the process may categorize reviews 707. They can be stored in a repository, and links or references to the reviews can be stored in various categories for future retrieval.

Certain reviews may also be designated to be delivered to a user specifically. For example, if a person who just ate great meal or ate a great movie want to actually recommend the meal/movie, as opposed to simply reviewing it, they may designate the review as a recommendation. They may even add friends 709 to whom the recommendation should be delivered.

The recommendation can be sent in the form of structured text (for example XML), and email, or a vehicle delivered message. The process can set the message to deliver to the vehicle first, and then to a secondary device if the vehicle is unavailable, or simply to deliver to the vehicle, once available, etc. If the recommendation is requested 711, the process can send the message 713 or queue the message for delivery at an appropriate time. Otherwise, the process can just store the message/review and move on.

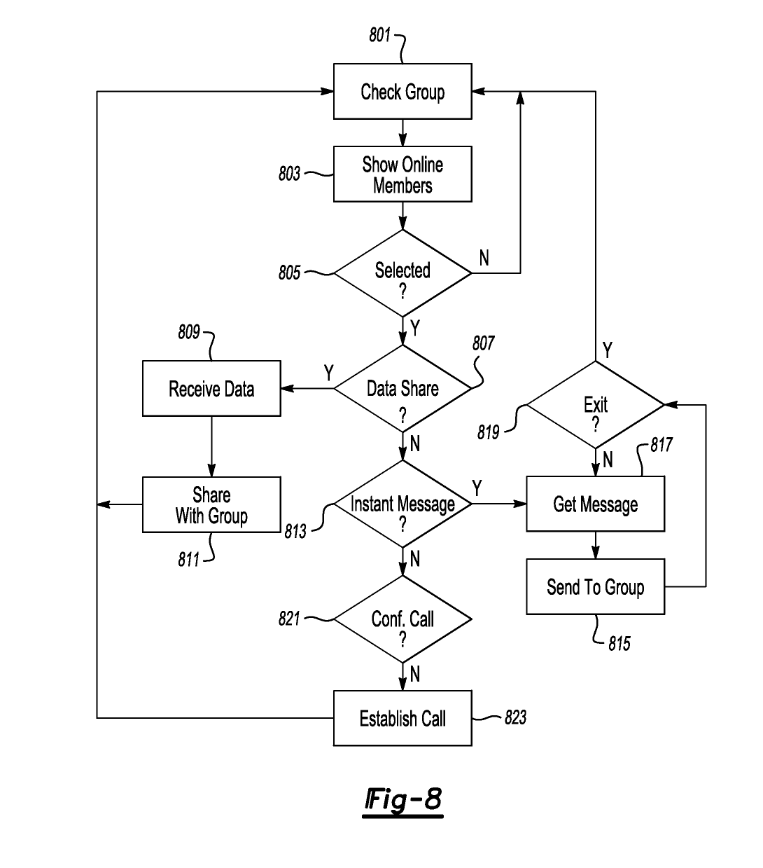

FIG. 8 shows an illustrative example of a process for group communication. In this illustrative example, multiple users can add friends also owning vehicles with appropriate computing systems for communication. It may additionally be possible to communicate with users on PCs, wireless devices, etc. through this system. Members who are logged in or online in some fashion can show up on a user's vehicle display.

In this example, the process checks one or more groups selected for user communication 801. The groups could be of any sort, but since the users of the group will be able to communicate directly with the occupants in the vehicle, it is likely that these groups will often be comprised of close friends. The group is checked to determine which users are online, and then a list of online members is presented 803.

In this example, the vehicle computing system is capable of remote communication with a remote location through a connected wireless device. This connection can also be used to relay real-time voice messages between multiple vehicles. For example, if several friends were on a road trip, they could use this real time communication to send messages between the vehicles, without having to make phone calls. Also, since the technology can be used to deliver a message from one sender to multiple recipients, a conference call like atmosphere can be established.

The user in this process selects one or more people with whom information sharing is desired 805. Until at least one user is selected, in this example, the process continues to loop, checking for online users and providing options for selection. Since people will often be entering and exiting vehicles at random points throughout a day, this can help keep a current list of who is online and available for chatting. Of course, users can also disable the function if desired, permanently or temporarily.

In this example, there are three actions to be taken with respect to a user. A data share option, an IM option and a conference call option. In this example, the data share option relates to sharing a review, a coupon, a photo, a video, a song, etc. The IM option relates to one on one communication between two vehicles, established without placing a physical phone call between the two users. The conference call option relates to the creation of a conference call like environment, in which many users can communicate over a vehicle communication network.

If the data share option is chosen 807, the process receives data from a user 809. The user data can be uploaded from any reasonable source, or can be retrieved based on a user designation. For example, a user could snap a photograph with their phone and upload it to a vehicle computing system. The illustrative process could then be used to distribute the photograph to one or more users with whom the driver communicates. Once the data is uploaded, the process shares the data with any selected members of the group 811.

In addition to data sharing, an IM option may be chosen 813. The IM option receives a message from a user for delivery to the group 815. The message could be typed on a PC, created via speech to text, sent from a tablet PC or handheld, etc. Once the message is received the process then sends the message to the group (or individual) 817. Until a conversation is completed, this process can continue.

In another example, a conference call option may be selected 821 and a conference call may be established 823. The conference call could be done using cloud based calling, or by transferring messages from various participants to other participants. A user with keyboard access could type messages and receive spoken messages in text form. The typed messages could be read aloud to members who don't have visual screens or who could be distracted by reading messages.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method comprising:
providing a list of driver-affiliated users, based at least on a driver designation of affiliation, whose vehicle computing system (VCS)-equipped vehicles are currently powered;
receiving input corresponding to a selection of at least one user;
receiving a message for delivery to a vehicle computing system (VCS) of the selected at least one user(s); and
delivering the message from a driver VCS to a VCS of the selected user(s).

2. The method of claim 1, wherein the list of driver-affiliated users further includes all users affiliated with the driver, regardless of vehicle power state, and further includes indicia of vehicle power state.

3. The method of claim 1, wherein the message includes a voice message.

4. The method of claim 1, wherein the message includes a text message.

5. The method of claim 1, wherein the message includes a data attachment.

6. The method of claim 1, wherein the message includes a current destination input into a vehicle navigation system.

7. A system comprising:
a processor configured to:
provide a list of driver-affiliated users, based at least on a driver designation of affiliation, whose vehicle computing system (VCS)-equipped vehicles are currently powered;
receive input corresponding to a selection of at least one user;
receive a message for delivery to a vehicle computing system (VCS) of the selected at least one user(s); and
deliver the message from a driver VCS to a VCS of the selected user(s).

8. The system of claim 7, wherein the list of driver-affiliated users further includes all users affiliated with the driver, regardless of vehicle power state, and further includes indicia of vehicle power state.

9. The system of claim 7, wherein the message includes a voice message.

10. The system of claim 7, wherein the message includes a text message.

11. The system of claim 7, wherein the message includes a data attachment.

12. The system of claim 7, wherein the message includes a current destination input into a vehicle navigation system.

13. A computer readable storage medium, storing instructions that, when executed by a processor, cause the processor to perform a method comprising:
providing a list of driver-affiliated users, based at least on a driver designation of affiliation, whose vehicle computing system (VCS)-equipped vehicles are currently powered;
receiving input corresponding to a selection of at least one user;
receiving a message for delivery to a vehicle computing system (VCS) of the selected at least one user(s); and
delivering the message from a driver VCS to a VCS of the selected user(s).

14. The storage medium of claim 13, wherein the list of driver-affiliated users further includes all users affiliated with the driver, regardless of vehicle power state, and further includes indicia of vehicle power state.

15. The storage medium of claim 13, wherein the message includes a voice message.

16. The storage medium of claim 13, wherein the message includes a text message.

17. The storage medium of claim 13, wherein the message includes a data attachment.

18. The storage medium of claim 13, wherein the message includes a current destination input into a vehicle navigation system.
